(19) United States
(12) Patent Application Publication
(10) Pub. No.: US 2025/0166604 A1
(43) Pub. Date: May 22, 2025

(54) SIMULATING SECONDARY USER PRESENCE USING VOICE MODULATION

(71) Applicant: Motorola Mobility LLC, Chicago, IL (US)

(72) Inventors: Amit Kumar Agrawal, Bangalore (IN); Satyabrata Rout, Bangalore (IN); Himanshu Chug, Bangalore (IN)

(73) Assignee: Motorola Mobility LLC, Chicago, IL (US)

(21) Appl. No.: 18/513,594

(22) Filed: Nov. 19, 2023

(51) Int. Cl. G10L 13/033

(52) U.S. Cl. CPC G10L 13/033

(57) ABSTRACT

In aspects of simulating secondary user presence using voice modulation, a system and/or a media device in the system implements an audio modulation manager that detects an incoming communication in an environment. The audio modulation manager can determine to simulate a secondary user presence of a secondary user in the environment using audio modulation. The audio modulation manager can then delegate an outgoing audio communication to a media device for playback in the environment to simulate the secondary user presence of the secondary user. In implementations, the outgoing audio communication is voiced by a user in the environment, and the audio modulation manager modulates the outgoing audio communication to simulate the secondary user presence.

### BACKGROUND

Society in general has experienced a rapid increase in the frequency and types of deliveries that a person may receive at home, such as for groceries, mail and package services, meals, household items, and generally any type of consumer product delivery and/or service. However, a small child, an elderly person, or any other type of possibly vulnerable person may be the only person in a home or residence when a delivery is attempted, and the person may not feel comfortable to answer the door alone or engage in a response to an incoming audio/video call, such as on a home intercom system. Many times, the homeowner(s), who are generally the capable adults of a residence, are off to work or for other obligations, while an elderly parent and/or school-aged children are home alone for possibly a few hours.

### BRIEF DESCRIPTION OF THE DRAWINGS

Implementations of the techniques for simulating secondary user presence using voice modulation are described with reference to the following Figures. The same numbers may be used throughout to reference like features and components shown in the Figures.

FIG. 1 illustrates an example system for simulating secondary user presence using voice modulation in accordance with one or more implementations as described herein.

FIG. 2 illustrates an example procedure simulating secondary user presence using voice modulation in accordance with one or more implementations as described herein.

FIGS. 3-5 illustrate example methods for simulating secondary user presence using voice modulation in accordance with one or more implementations of the techniques described herein.

FIG. 6 illustrates various components of an example device that may be used to implement the techniques for simulating secondary user presence using voice modulation as described herein.

### DETAILED DESCRIPTION

Implementations of the techniques for simulating secondary user presence using voice modulation may be implemented as described herein. A media device, such as any type of a wireless device, home console, mobile phone, client device, tablet, computing, communication, entertainment, gaming, media playback, and/or any other type of computing, consumer, and/or electronic device can be configured to perform techniques for simulating secondary user presence using voice modulation as described herein. In one or more implementations, a media device includes an audio modulation manager, which can be used to implement aspects of the techniques described herein. In one or more devices, systems, and/or services, the audio modulation manager can be implemented, at least in part, using a machine learning model and/or algorithm (e.g., a neural network, artificial intelligence (AI) algorithms) to implement the described techniques for simulating secondary user presence using voice modulation.

The frequency with which a person may receive deliveries at home has increased rapidly, such as for groceries, mail and package services, meals, household items, services, and generally any type of consumer product delivery and/or services. Although a household or residence may experience several deliveries and and/or outside third party contacts daily, a small child, an elderly person, or any other type of possibly vulnerable person may be the only person in the home or residence when a delivery is attempted, and the person may not feel comfortable to answer the door alone or engage in a response to an incoming audio/video call, such as on a home intercom system. Many times, the homeowner(s), who are generally the capable adults in a residence, are off to work or for other obligations, while an elderly parent and/or school-aged children are home alone.

Notably, a homeowner likely does not want to put a younger child and/or an elderly parent who may also live in the home in a situation where he or she may be home alone and is having to receive deliveries or interface with other third party service providers (e.g., home repair technicians, lawn service providers, and the like). Some conventional solutions (e.g., Internet-of-things devices) at least provide an ability to preview who may be at the door of a residence, and a person who is home alone can decide whether or not to unlock and open the door. However, current systems do not provide a solution to make it appear as if multiple people are in the residence, and notably, a solution for the appearance of the existence of a primary homeowner or a capable adult presence in the residence, which provides an environment of safety and security.

In a smart home environment, an audio emulation mode of a voice modulation system can be enabled or initiated as a safe mode so that elderly adults and/or younger children who remain in the environment are provided another layer of safety and security by simulating the presence of at least another person in the home or residence. This activation of the audio emulation mode can apply to all of the connected devices in a smart home environment, such as a smart intercom system, a mobile device (e.g., a mobile phone), a tablet device, any computer devices, and/or any type of device that implements a system to simulate a secondary user presence of the at least another person in a home or residence environment.

In aspects of the described techniques, a system, a mobile device, and/or a media device implements an audio modulation manager of a voice modulation system that receives or detects an incoming communication in an environment, such as an audio/video call on a mobile phone or smart home intercom system. The audio modulation manager can determine to simulate a secondary user presence of a secondary user in the environment using audio modulation, such as to generate modulated voice audio. The audio modulation manager can then delegate an outgoing audio communication of the modulated voice audio to a media device for playback in the environment to simulate the secondary user presence of the secondary user.

In implementations, the modulated voice audio that is output as the outgoing audio communication to simulate the secondary user presence may be any type of computer-generated audio, pre-recorded audio, or any other type of modulated audio file. The pre-recorded audio can include any type of recorded audio and/or video content, such as from the person who is the homeowner or the otherwise capable adult presence in a residence. When an incoming communication and/or someone approaching the home or residence is detected or received, the audio modulation manager can prompt a pre-recorded audio or computer-generated audio for playback by a media playback device to simulate the secondary user presence. Additionally, the computer-generated audio can be modulated and generated to emulate the speech patterns, tone, and/or pitch of a secondary user, such as the person who is the homeowner or the otherwise capable adult presence in a residence. For example, the audio modulation manager can generate the computer-generated audio to sound like the parent of a young child to simulate the presence of the parent in the environment.

In implementations, the voice audio that is modulated and generated as the outgoing audio communication by the audio modulation manager may be voiced by a person in the environment, such as by a younger child or an elderly adult, who provides user input audio. The audio modulation manager modulates the user input audio as voice audio to generate the outgoing audio communication to simulate the secondary user presence, such as the presence of a primary homeowner or a capable adult in a residence. In further implementations, a user may also select a pre-recorded audio selection or select a computer-generated audio for modulation and/or output by the audio modulation manager as the outgoing audio communication, such as from a media playback device in the environment.

While features and concepts of the described techniques for simulating secondary user presence using voice modulation is implemented in any number of different devices, systems, environments, and/or configurations, implementations of the techniques for simulating secondary user presence using voice modulation are described in the context of the following example devices, systems, and methods.

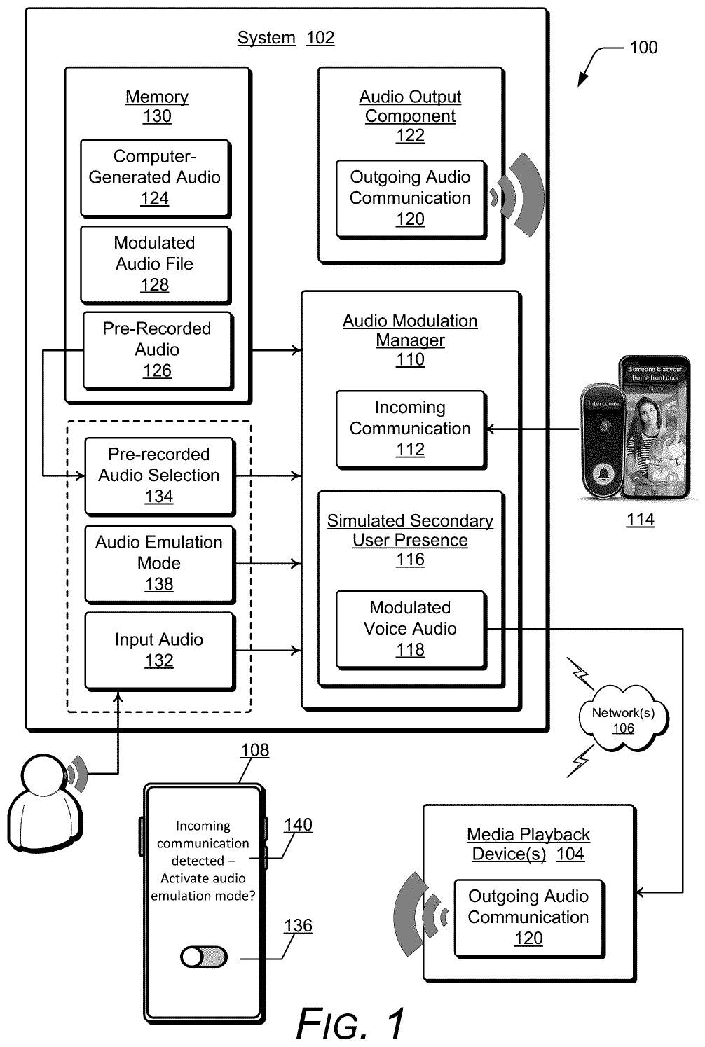

FIG. 1 illustrates an example environment 100, in which aspects of the described techniques for simulating secondary user presence using voice modulation can be implemented. The example environment 100 includes a system 102, which may be integrated in or implemented as any type of computing, consumer, and/or electronic device. The example environment 100 also includes one or more media playback devices 104, a communication network 106, and may include a mobile device 108. In one or more implementations, the system 102 may be integrated with, or implemented by, the mobile device 108 and/or any of the media playback devices 104. Accordingly, the mobile device 108 and/or a media playback device 104 can be configured to perform the techniques for simulating secondary user presence using voice modulation as described herein. Examples of the system 102, a media playback device 104, and/or the mobile device 108 include any type of a wireless device, media device, mobile phone, flip phone, client device, companion device, tablet, computing device, communication device, entertainment device, gaming device, and/or any other type of computing, consumer, and/or electronic device.

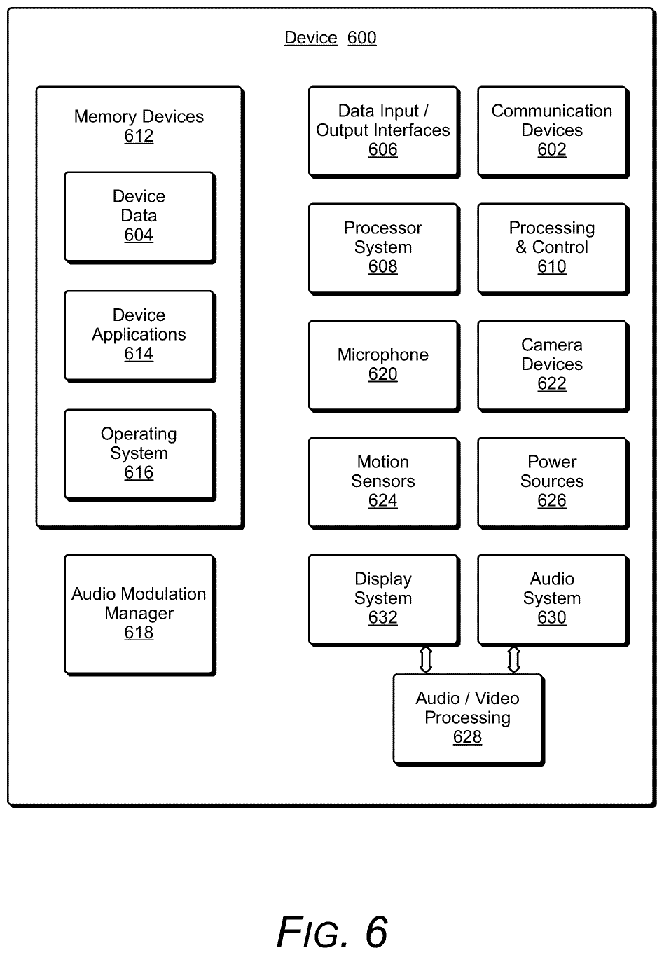

Any of the system 102, a media playback device 104, and/or the mobile device 108 can be implemented with various components, such as a processor system and memory, as well as any number and combination of different components as further described with reference to the example device shown in FIG. 6. In implementations, the system 102, a media playback device 104, and/or the mobile device 108 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices includes at least one of a WiFi radio, a cellular radio, a global positioning satellite (GPS) radio, or any available type of device communication interface.

In implementations, the system, devices, applications, modules, servers, and/or services described herein communicate via the communication network 106, such as for data communication between the system and/or devices. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 can include mobile operator networks that are managed by a mobile network operator and/or other network operators, such as a communication service provider, mobile phone provider, and/or Internet service provider.

Any of the system 102, a media playback device 104, and/or the mobile device 108 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display device or display screen of the mobile device 108. Generally, an application user interface, or any other type of video, image, graphic, and the like is digital image content that is displayable on the display device or display screen of the mobile device.

In the example environment 100 for simulating secondary user presence using voice modulation, the system 102 implements an audio modulation manager 110 (e.g., as a device application). As shown in this example, the audio modulation manager 110 represents functionality (e.g., logic, software, and/or hardware) enabling aspects of the described techniques for simulating secondary user presence using voice modulation. The audio modulation manager 110 can be implemented as computer instructions stored on computer-readable storage media and can be executed by a processor system of the system 102. Alternatively, or in addition, the audio modulation manager 110 can be implemented at least partially in hardware of the system (or device).

In one or more implementations, the audio modulation manager 110 includes independent processing, memory, and/or logic components functioning as a computing and/or electronic device integrated with the system 102. Alternatively, or in addition, the audio modulation manager 110 can be implemented in software, in hardware, or as a combination of software and hardware components. In this example, the audio modulation manager 110 is implemented as a software application or module, such as executable software instructions (e.g., computer-executable instructions) that are executable with a processor system to implement the techniques and features described herein. As a software application or module, the audio modulation manager 110 can be stored on computer-readable storage memory (e.g., memory of a device), or in any other suitable memory device or electronic data storage implemented with the manager. Alternatively or in addition, the audio modulation manager 110 is implemented in firmware and/or at least partially in computer hardware. For example, at least part of the audio modulation manager 110 is executable by a computer processor, and/or at least part of the audio modulation manager is implemented in logic circuitry.

In one or more implementations, the audio modulation manager 110 can be implemented, at least in part, using a machine learning (ML) model and/or algorithm (e.g., a neural network, artificial intelligence (AI) algorithms) that can activate an audio emulation mode for all of the connected devices in a smart home environment, and implement the techniques for simulating secondary user presence using voice modulation. The audio modulation manager 110 implemented as a machine learning model may include AI, an ML model or algorithm, a convolutional neural network (CNN), and/or any other type of machine learning model to display compatible product recommendations. As used herein, the term “machine learning model” refers to a computer representation that is trainable based on inputs to approximate unknown functions. For example, a machine learning model can utilize algorithms to learn from, and make predictions on, inputs of known data (e.g., training and/or reference images) by analyzing the known data to learn to generate outputs, such as to select outgoing audio communications, as well as who's voice is used to emulate a message for an outgoing audio communication.

In this example environment 100, the audio modulation manager 110 of the system 102 can detect and/or receive an incoming communication 112, such as an audio/video call on a mobile phone or smart home intercom system, or from any other type of communication device 114 or system. An incoming communication 112 can include any type of communication and/or audio, such as from a person (e.g., a voice), a phone call, a video call, a doorbell ring, a knock, and/or any other type of communication or audio in the environment that is audibly detected or received by the audio modulation manager 110 of the system 102.

As described above, a small child, an elderly person, or any other type of possibly vulnerable person may be home alone in a residence (e.g., in environment 100), and may not feel comfortable to answer the door alone or engage in a response to an audio/video call. Accordingly, the audio modulation manager 110 can determine to simulate a secondary user presence 116 of one or more secondary users in the environment using audio modulation, such as to generate modulated voice audio 118. The audio modulation manager 110 can then delegate an outgoing audio communication 120 of the modulated voice audio 118 to at least one media playback device 104 for audible playback in the environment 100 to simulate the secondary user presence 116 of at least one secondary user. The modulated voice audio 118 can be manipulated to sound like a person who is the homeowner, the capable adult presence in the residence, and/or any other type of person who's presence would otherwise provide some additional level of safety and/or security to someone who is home alone. In this example, the system 102 can also include an audio output component 122 (e.g., a speaker device) via which the outgoing audio communication 120 can be emitted for playback in the environment 100 to simulate the secondary user presence 116 of the secondary user.

In implementations, the modulated voice audio 118 that is then output as the outgoing audio communication 120 to simulate the secondary user presence 116 may be any type of computer-generated audio 124, pre-recorded audio 126, or any other type of modulated audio file 128, any of which may be stored in memory 130 of the system 102 (e.g., or in a device memory of a device that implements the system 102). The pre-recorded audio 126 can include any type of recorded audio and/or video content, such as from the person who is the homeowner or the otherwise capable adult presence in the residence. When the incoming communication 112 and/or someone approaching the home or residence is detected or received, the audio modulation manager 110 can prompt a pre-recorded audio 126 for playback by a media playback device 104 in the environment 100 to simulate the secondary user presence 116.

In implementations, the computer-generated audio 124 can be modulated and generated to emulate the speech patterns, tone, and/or pitch of a secondary user, such as the person who is the homeowner or the otherwise capable adult presence in the residence. For example, the audio modulation manager 110 can generate the computer-generated audio 124 to sound like the parent of a young child to simulate the presence of the parent in the environment. Similarly, when the incoming communication 112 and/or someone approaching the home or residence is detected or received, the audio modulation manager 110 can prompt a computer-generated audio 124 for playback by a media playback device 104 in the environment 100 to simulate the secondary user presence 116.

In implementations, the audio modulation manager 110 can initiate to display one or more selectable pre-recorded and/or computer-generated audio communications that simulate the secondary user presence. For example, the audio modulation manager 110 can initiate a display of selectable audio messages, such as on the display device of the mobile device 108 (e.g., in an implementation in which the mobile device 108 integrates the system 102). The selectable audio messages may include, for example, outgoing audio communications in an adult voice saying to “leave the package at the door,” “we're in the middle of something, come back later,” or “can someone else get the door, I'm busy.” Any of these types of selectable pre-recorded and/or computer-generated audio communications indicate the presence of at least someone else in the residence. Additionally, a user of the mobile device 108 may also be able to select the person who's voice is used to emulate the message, such as a young child may select from options that include “Dad,” “Mom,” or “Big brother” as the adult voice that emulates a message for the outgoing audio communication 120. The display of the selectable pre-recorded and/or computer-generated audio communications may be initiated in response to the audio modulation manager 110 receiving or detecting the incoming communication 112, and the selections are displayed on the display device of the mobile device 108 for user selection. As noted above, the audio modulation manager 110 can be implemented, at least in part, using an ML model and/or AI algorithm (or a combination thereof) to activate the audio emulation mode for all of the connected devices in a smart home environment, as well as select outgoing audio communications and determine who's voice is used to emulate a message for an outgoing audio communication.

In implementations, the voice audio that is modulated and generated as the outgoing audio communication 120 may be voiced by a person in the environment 100, such as by a younger child or an elderly adult, who provides user input audio 132 that the audio modulation manager 110 modulates as the voice audio 118 to generate the outgoing audio communication 120 to simulate the secondary user presence 116, such as the presence of a primary homeowner or a capable adult in a residence. Alternatively, or in addition, the audio modulation manager 110 can communicate the modulated voice audio 118 to the memory 130 for storage as a pre-recorded audio 126 that may be selected for a subsequent outgoing audio communication.

The user input audio 132 may be received in the system 102 as any type of audio data that is associated with a user voice input, audio file, and/or any other type of digital content. The input audio 132 can be received via an integrated microphone of the system and/or a device. Additionally, the audio modulation manager 110 can receive the input audio 132 from any number of sources, such as from a device application, an audio application, or communicated over the communication network from a device in the system. In further implementations, a user may also select a pre-recorded audio selection 134 (or select a computer-generated audio) for modulation and/or output by the audio modulation manager 110 as the outgoing audio communication 120.

In implementations, the audio modulation manager 110 can initiate the display of a selectable prompt 136 by which a user can activate the audio emulation mode 138 of the system 102. For example, the audio modulation manager 110 initiates a display of the selectable prompt 136, such as on the display device of the mobile device 108 (e.g., in an implementation in which the mobile device 108 integrates the system 102). The display of the selectable prompt 136 may be initiated in response to receiving or detecting the incoming communication 112, and an informative communication 140 may also be displayed on the display device of the mobile device 108 in conjunction with the selectable prompt. The audio modulation manager 110 can initiate to modulate the voice audio 118 to generate the outgoing audio communication 120 to simulate the secondary user presence 116 based on activation of the audio emulation mode 138.

In a smart home environment, an audio emulation mode can be enabled or initiated as a safe mode so that elderly adults and/or younger children who remain in the environment are provided another layer of safety and security by simulating the presence of at least another person in the home or residence. This activation of the audio emulation mode can apply to all of the connected devices in a smart home environment, such as a smart intercom system, a mobile device 108 (e.g., a mobile phone), a tablet device, any computer devices, the system 102, and/or any type of device that implements the system. The media playback devices 104 in the environment 100 can include any type of a smart speaker, a smart TV, a smart doorbell, a mobile phone, a computing device, and/or any other type of media device. The audio modulation manager 110 can delegate at least one other media playback device 104 to output audio to simulate the secondary user in the environment.

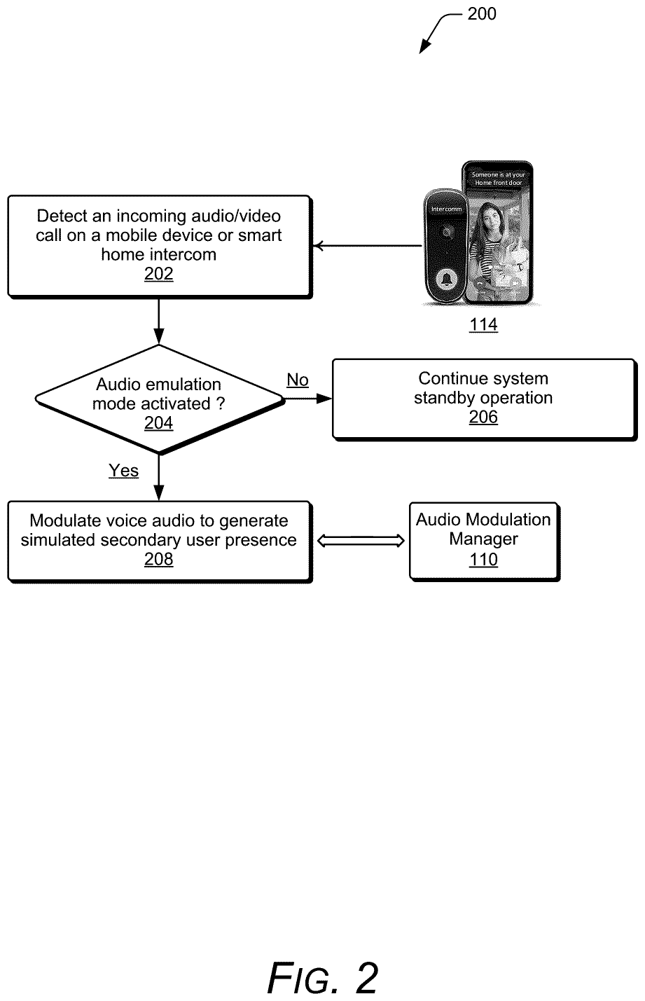

FIG. 2 illustrates example procedure 200 of simulating secondary user presence using voice modulation, as described herein. In this example procedure 200, an incoming audio/video call is detected on a mobile device or smart home intercom (at 202), such as an incoming audio/video call from a communication device 114 or system. A determination is made (at 204) as to whether the audio emulation mode 138 of the system is activated. If the audio emulation mode 138 is not activated (i.e., “No” from 206), then the system continues in a standby operation (at 206). If the audio emulation mode 138 is activated (i.e., “Yes” from 204), then a voice audio is modulated to generate a simulated secondary user presence 116 (at 208) by the audio modulation manager 110.

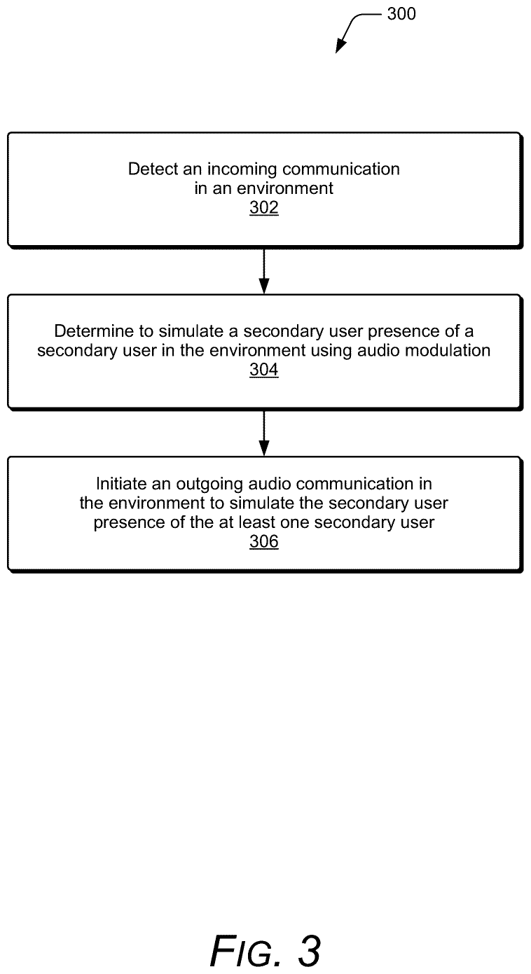

Example methods 300, 400, and 500 are described with reference to respective FIGS. 3, 4, and 5 in accordance with one or more implementations of simulating secondary user presence using voice modulation, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 for simulating secondary user presence using voice modulation. The order in which the method is described is not intended to be construed as a limitation, and any number or combination of the described method operations may be performed in any order to perform a method, or an alternate method.

At 302, an incoming communication is detected in an environment. For example, the audio modulation manager 110 detects or receives the incoming communication 112, such as an audio/video call on a mobile phone or smart home intercom system, or from any other type of communication device 114 or system. An incoming communication 112 can include any type of communication and/or audio, such as from a person (e.g., a voice), a phone call, a video call, a doorbell ring, a knock, and/or any other type of communication or audio in the environment that is audibly detected or received by the audio modulation manager 110 of the system 102.

At 304, a determination is made simulate a secondary user presence of a secondary user in the environment using audio modulation. For example, the audio modulation manager 110 determines to simulate the secondary user presence 116 of a secondary user in the environment 100 using audio modulation (e.g., the modulated voice audio 118). The modulated voice audio 118 can be manipulated to sound like a person who is a homeowner, or the capable adult presence in a residence, and/or any other type of person who's presence would otherwise provide some additional level of safety and/or security to someone who is home alone.

At 306, an outgoing audio communication is initiated in the environment to simulate the secondary user presence of the secondary user. For example, the audio modulation manager 110 initiates the outgoing audio communication 120 in the environment 100 to simulate the secondary user presence 116 of the secondary user. The modulated voice audio 118 that is output as the outgoing audio communication 120 to simulate the secondary user presence 116 may be any type of the computer-generated audio 124, the pre-recorded audio 126, or any other type of modulated audio file 128. The pre-recorded audio 126 can include any type of recorded audio and/or video content, such as from the person who is the homeowner or the otherwise capable adult presence in the residence. The computer-generated audio 124 can be modulated and generated to emulate the speech patterns, tone, and/or pitch of a secondary user, such as the person who is the homeowner or the otherwise capable adult presence in the residence. For example, the audio modulation manager 110 can generate the computer-generated audio 124 to sound like the parent of a young child to simulate the presence of the parent in the environment.

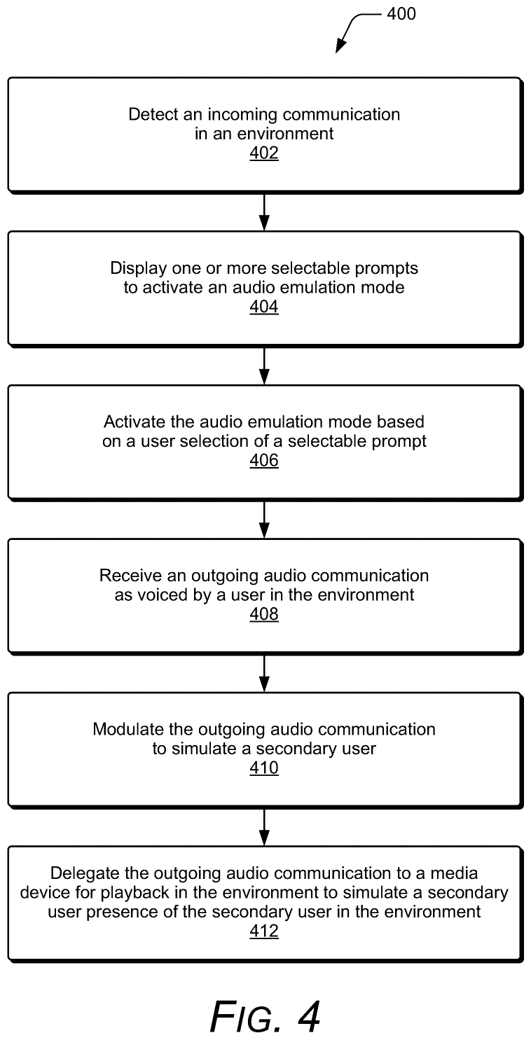

FIG. 4 illustrates example method(s) 400 for simulating secondary user presence using voice modulation. The order in which the method is described is not intended to be construed as a limitation, and any number or combination of the described method operations may be performed in any order to perform a method, or an alternate method.

At 402, an incoming communication is detected in an environment. For example, the audio modulation manager 110 detects or receives the incoming communication 112, such as an audio/video call on a mobile phone or smart home intercom system, or from any other type of communication device 114 or system. An incoming communication 112 can include any type of communication and/or audio, such as from a person (e.g., a voice), a phone call, a video call, a doorbell ring, a knock, and/or any other type of communication or audio in the environment that is audibly detected or received by the audio modulation manager 110 of the system 102.

At 404, one or more selectable prompts are displayed to activate an audio emulation mode. For example, the audio modulation manager 110 initiates to display the selectable prompt 136 by which a user can activate the audio emulation mode 138 of the system 102. The audio modulation manager 110 initiates the display of the selectable prompt 136 on the display device of the mobile device 108 (e.g., in an implementation in which the mobile device 108 integrates the system 102). At 406, the audio emulation mode is activated based on a user selection of a selectable prompt. For example, the audio modulation manager 110 activates the audio emulation mode 138 based on a user selection of a selectable prompt 136.

At 408, an outgoing audio communication is received as voiced by a user in the environment, and at 410, the outgoing audio communication is modulated to simulate a secondary user. For example, the voice audio that is modulated and generated as the outgoing audio communication 120 may be voiced by a person in the environment 100, such as by a younger child or an elderly adult, who provides the user input audio 132 that the audio modulation manager 110 modulates as the voice audio 118 to generate the outgoing audio communication 120 to simulate the secondary user presence 116, such as the presence of a primary homeowner or a capable adult in a residence.

At 412, the outgoing audio communication is delegated to a media device for playback in the environment to simulate a secondary user presence of the secondary user in the environment. For example, the audio modulation manager 110 delegates the outgoing audio communication 120 to a media playback device 104 for playback in the environment 100 to simulate the secondary user presence 116 of the secondary user. Alternatively, or in addition, the system 102 includes the audio output component 122 (e.g., a speaker device) via which the outgoing audio communication 120 is emitted for playback in the environment 100 to simulate the secondary user presence 116 of the secondary user.

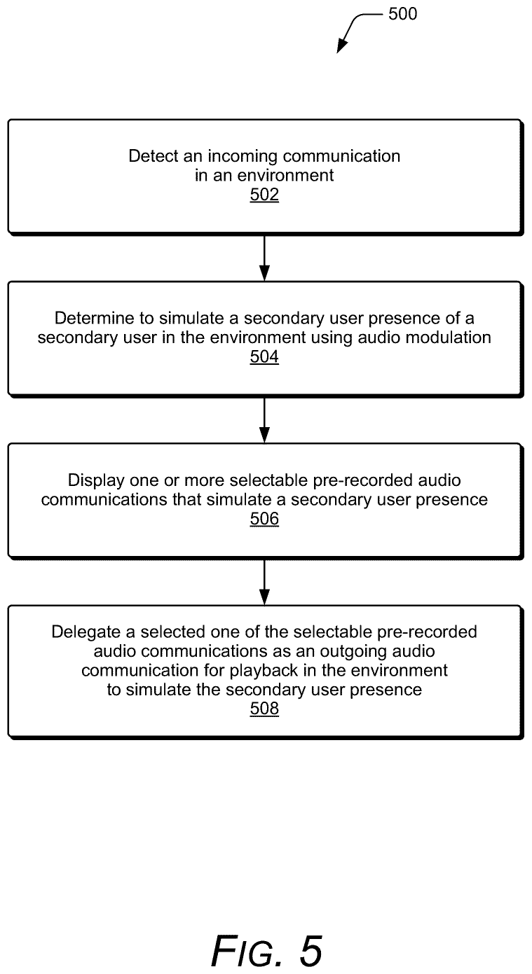

FIG. 5 illustrates example method(s) 500 for simulating secondary user presence using voice modulation. The order in which the method is described is not intended to be construed as a limitation, and any number or combination of the described method operations may be performed in any order to perform a method, or an alternate method.

At 502, an incoming communication is detected in an environment. For example, the audio modulation manager 110 detects or receives the incoming communication 112, such as an audio/video call on a mobile phone or smart home intercom system, or from any other type of communication device 114 or system. An incoming communication 112 can include any type of communication and/or audio, such as from a person (e.g., a voice), a phone call, a video call, a doorbell ring, a knock, and/or any other type of communication or audio in the environment that is audibly detected or received by the audio modulation manager 110 of the system 102.

At 504, a determination is made simulate a secondary user presence of a secondary user in the environment using audio modulation. For example, the audio modulation manager 110 determines to simulate the secondary user presence 116 of a secondary user in the environment 100 using audio modulation (e.g., the modulated voice audio 118). The modulated voice audio 118 can be manipulated to sound like a person who is a homeowner, or the capable adult presence in a residence, and/or any other type of person who's presence would otherwise provide some additional level of safety and/or security to someone who is home alone.

At 506, one or more selectable pre-recorded audio communications are displayed that simulate a secondary user presence. For example, the audio modulation manager 110 initiates to display one or more selectable pre-recorded and/or computer-generated audio communications that simulate the secondary user presence. The selectable audio messages can be displayed for selection on the display device of the mobile device 108, and any type of the selectable pre-recorded and/or computer-generated audio communications can be used to indicate the presence of at least someone else in the residence.

At 508, a selected one of the selectable pre-recorded audio communications is delegated as an outgoing audio communication for playback in the environment to simulate the secondary user presence. For example, the audio modulation manager 110 delegates a selected one of the pre-recorded and/or computer-generated audio communications as the outgoing audio communication 120 for playback in the environment 100 to simulate the secondary user presence 116.

FIG. 6 illustrates various components of an example device 600, which can implement aspects of the techniques and features for simulating secondary user presence using voice modulation, as described herein. The example device 600 may be implemented as any of the devices described with reference to the previous FIGS. 1-5, such as any type of a wireless device, mobile device, mobile phone, flip phone, client device, companion device, display device, tablet, computing, communication, entertainment, gaming, media playback, and/or any other type of computing and/or electronic device. For example, any one or more of the system 102, a media playback device 104, and the mobile device 108 described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In this example, the device 600 includes an audio modulation manager 618 that implements various aspects of the described features and techniques described herein. The audio modulation manager 618 may be implemented with hardware components and/or in software as one of the device applications 614, such as when the example device 600 is implemented as any one or more of the system 102, a media playback device 104, and the mobile device 108 described with reference to FIGS. 1-5. An example of the audio modulation manager 618 is the audio modulation manager 110 implemented by the system 102, such as a software application and/or as hardware components in the system and/or in the mobile device, for example. In implementations, the audio modulation manager 618 may include independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for simulating secondary user presence using voice modulation have been described in language specific to features and/or methods, the appended claims are not necessarily limited to the specific features or methods described. Rather, the specific features and methods are disclosed as example implementations for simulating secondary user presence using voice modulation, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A system, comprising: at least one processor coupled with a memory; and an audio modulation manager implemented at least partially in hardware and configured to: detect an incoming communication in an environment; determine to simulate a secondary user presence of at least one secondary user in the environment using audio modulation; and delegate an outgoing audio communication to at least one media device for playback in the environment to simulate the secondary user presence of the at least one secondary user.

Alternatively, or in addition to the above-described system, any one or combination of: the outgoing audio communication is voiced by a user in the environment; and the audio modulation manager is configured to modulate the outgoing audio communication to simulate the secondary user. The audio modulation manager is configured to initiate a selectable prompt to activate an audio emulation mode of the system; and modulate the outgoing audio communication to simulate the secondary user presence based at least in part on activation of the audio emulation mode. The outgoing audio communication is pre-recorded audio that simulates the secondary user presence. The outgoing audio communication is computer-generated audio that simulates the secondary user presence. The computer-generated audio is modulated utilizing at least a tone and a pitch of a related person to a user in the environment to simulate the secondary user presence. The audio modulation manager is configured to initiate a display of one or more selectable pre-recorded audio communications that simulate the secondary user presence; and delegate a selected one of the one or more selectable pre-recorded audio communications as the outgoing audio communication to the at least one media device for the playback in the environment to simulate the secondary user presence.

A method, comprising: detecting an incoming communication in an environment; determining to simulate a secondary user presence of at least one secondary user in the environment using audio modulation; and initiating an outgoing audio communication in the environment to simulate the secondary user presence of the at least one secondary user.

Alternatively, or in addition to the above-described method, any one or combination of: the outgoing audio communication is pre-recorded audio that simulates the secondary user presence. The outgoing audio communication is computer-generated audio that simulates the secondary user presence, the computer-generated audio modulated utilizing at least a tone and a pitch of a related person to a user in the environment to simulate the secondary user presence. The method further comprising initiating a display of one or more selectable pre-recorded audio communications that simulate the secondary user presence; and delegating a selected one of the one or more selectable pre-recorded audio communications as the outgoing audio communication for playback in the environment to simulate the secondary user presence.

A media device, comprising: at least one processor coupled with a memory, the memory configured to store at least one modulated audio file; and an audio modulation manager implemented at least in part with a machine learning model and configured to cause the media device to detect an incoming communication in an environment; determine to simulate a secondary user presence of at least one secondary user in the environment; and initiate the at least one modulated audio file as an outgoing audio communication in the environment to simulate the secondary user presence.

Alternatively, or in addition to the above-described media device, any one or combination of: the audio modulation manager is configured to cause the media device to delegate the at least one modulated audio file to at least one audio playback device to simulate the secondary user presence of the at least one secondary user in the environment. The audio modulation manager is configured to cause the media device to activate an audio emulation mode based at least in part on the incoming communication being detected. The at least one modulated audio file is recorded audio that simulates the secondary user presence. The recorded audio is voiced by a user in the environment, and the audio modulation manager is configured to cause the media device to modulate the recorded audio to simulate the secondary user. The at least one modulated audio file is computer-generated audio that simulates the secondary user presence, and the at least one modulated audio file is modulated utilizing at least a tone and a pitch of a related person to a user in the environment to simulate the secondary user presence.

1. A system, comprising:
at least one processor coupled with a memory; and
an audio modulation manager implemented at least partially in hardware and configured to:
detect an incoming communication in an environment;
determine to simulate a secondary user presence of at least one secondary user in the environment using audio modulation; and
delegate an outgoing audio communication to at least one media device for playback in the environment to simulate the secondary user presence of the at least one secondary user.

2. The system of claim 1, wherein:
the outgoing audio communication is voiced by a user in the environment; and
the audio modulation manager is configured to modulate the outgoing audio communication to simulate the at least one secondary user.

3. The system of claim 1, wherein the audio modulation manager is configured to:
initiate a selectable prompt to activate an audio emulation mode of the system; and
modulate the outgoing audio communication to simulate the secondary user presence based at least in part on activation of the audio emulation mode.

4. The system of claim 1, wherein the outgoing audio communication is pre-recorded audio that simulates the secondary user presence.

5. The system of claim 1, wherein the outgoing audio communication is computer-generated audio that simulates the secondary user presence.

6. The system of claim 5, wherein the computer-generated audio is modulated utilizing at least a tone and a pitch of a related person to a user in the environment to simulate the secondary user presence.

7. The system of claim 1, wherein the audio modulation manager is configured to:
initiate a display of one or more selectable pre-recorded audio communications that simulate the secondary user presence; and
delegate a selected one of the one or more selectable pre-recorded audio communications as the outgoing audio communication to the at least one media device for the playback in the environment to simulate the secondary user presence.

8. A method, comprising:
detecting an incoming communication in an environment;
determining to simulate a secondary user presence of at least one secondary user in the environment using audio modulation; and
initiating an outgoing audio communication in the environment to simulate the secondary user presence of the at least one secondary user.

9. The method of claim 8, further comprising:
delegating the outgoing audio communication to at least one media device for playback in the environment to simulate the secondary user presence of the at least one secondary user.

10. The method of claim 8, further comprising:
receiving the outgoing audio communication as voiced by a user in the environment; and
modulating the outgoing audio communication to simulate the at least one secondary user.

11. The method of claim 8, further comprising:
initiating to display a selectable prompt to activate an audio emulation mode; and
modulating the outgoing audio communication to simulate the secondary user presence based at least in part on activation of the audio emulation mode.

12. The method of claim 8, wherein the outgoing audio communication is pre-recorded audio that simulates the secondary user presence.

13. The method of claim 8, wherein the outgoing audio communication is computer-generated audio that simulates the secondary user presence, the computer-generated audio modulated utilizing at least a tone and a pitch of a related person to a user in the environment to simulate the secondary user presence.

14. The method of claim 8, further comprising:
initiating a display of one or more selectable pre-recorded audio communications that simulate the secondary user presence; and
delegating a selected one of the one or more selectable pre-recorded audio communications as the outgoing audio communication for playback in the environment to simulate the secondary user presence.

15. A media device, comprising:
at least one processor coupled with a memory, the memory configured to store at least one modulated audio file; and
an audio modulation manager implemented at least in part with a machine learning model and configured to cause the media device to:
detect an incoming communication in an environment;
determine to simulate a secondary user presence of at least one secondary user in the environment; and
initiate the at least one modulated audio file as an outgoing audio communication in the environment to simulate the secondary user presence.

16. The media device of claim 15, wherein the audio modulation manager is configured to cause the media device to delegate the at least one modulated audio file to at least one audio playback device to simulate the secondary user presence of the at least one secondary user in the environment.

17. The media device of claim 15, wherein the audio modulation manager is configured to cause the media device to activate an audio emulation mode based at least in part on the incoming communication being detected.

18. The media device of claim 15, wherein the at least one modulated audio file is recorded audio that simulates the secondary user presence.

19. The media device of claim 18, wherein the recorded audio is voiced by a user in the environment, and the audio modulation manager is configured to cause the media device to modulate the recorded audio to simulate the at least one secondary user.

20. The media device of claim 15, wherein the at least one modulated audio file is computer-generated audio that simulates the secondary user presence, and the at least one modulated audio file is modulated utilizing at least a tone and a pitch of a related person to a user in the environment to simulate the secondary user presence.
